(19) United States
(12) Patent Application Publication
(10) Pub. No.: US 2018/0285530 A9
(43) Pub. Date: Oct. 4, 2018

(54) Valve clip prediction

(71) Applicant: Siemens Medical Solutions USA, Inc., Malvern, PA (US)

(72) Inventors: Ronald Sipiorski, Carpentersville, IL (US); Martin Trini, Schaumburg, IL (US)

(21) Appl. No.: 15/051,515

(22) Filed: Feb. 23, 2016

Related U.S. Application Data
(60) Provisional application No. 62/130,175, filed on Mar. 9, 2015.

(51) Int. Cl. G06F 19/00

(52) U.S. Cl. CPC G06F 19/3437

(57) ABSTRACT

Embodiments relate to a method and system for calculating an optimal position for a valve clip to be placed and/or an optimal type of valve clip to be used for placement in a patient, based upon a simulation of the blood flow for the valve. Parameters that influence the simulation of blood flow for the mitral valve are used to conduct the simulation, the results of which are compared against certain predefined metrics. One or more metrics may be defined to analyze the effective regurgitation resulting from computational fluid dynamics (CFD) calculations. A valve clip and/or a clip position may be selected or determined to be preferred based upon flow characteristics calculated for the valve clip and/or the clip position under the CFD simulation. Appropriate instructions or other guidance information to appropriately place and affix the valve clip into the optimal position is provided via a user interface.

### CROSS-REFERENCE TO RELATED APPLICATIONS

This application claims priority to U.S. Provisional Patent Application No. 62/130,175, filed on Mar. 9, 2015 and entitled “Valve Clip Prediction,” the contents of which are herein incorporated by reference in their entirety.

### TECHNOLOGY FIELD

The present invention relates generally to predicting parameters for valve clip placement in a patient, and more particularly to predicting an optimal valve clip type and position for placement in a patient.

### BACKGROUND

A mitral valve clip is used to clip leaflets of the mitral valve together to repair the valve, thus reducing blood flow into the left atrium of the heart, as a treatment against, for example, degenerative mitral regurgitation. The treatment is delivered via catheter and guided to the mitral valve by X-ray. Presently, the placement and adjustment of a mitral valve clip by an interventional cardiologist in a patient is accomplished by trial and error. The process is often very time consuming and can cause anatomical damage, especially since several attempts may be needed to find a reasonable position for the clip to reside. It is also not assured that the final resting position of the clip through this process is the optimal one.

Thus, what is needed is a prediction model to replace the trial and error process, and to provide the cardiologist with a preferred location for the valve clip to be placed, along with the preferred clip type to be used in the placement.

### SUMMARY

Embodiments of the present invention provide a method and system for predicting an optimal position for a valve clip to be placed and/or an optimal type of valve clip to be used. According to embodiments disclosed herein, a simulation of the blood flow for the mitral valve is used to calculate the optimal position for the valve clip as well as the optimal type of clip to be used.

In an embodiment, a system for valve clip placement comprises a processor configured to: receive one or more parameters that influence a simulation of blood flow for a mitral valve; define one or more metrics for an acceptable simulation result; conduct the simulation of the blood flow for the mitral valve based on one or more of the one or more received parameters; compare results of the simulation with the defined one or more metrics; re-conduct the simulation of the blood flow for the mitral valve based on a re-parameterization of one or more of the one or more received parameters if the comparison indicates an unacceptable simulation result, wherein the re-conducting is performed until the acceptable simulation result is accomplished as determined by a comparison of the results of the re-conducted simulation with the defined one or more metrics; and determine at least one of a valve clip position and a valve clip type based on the acceptable simulation result from one of the conducted simulation and the re-conducted simulation. A user interface in communication with the processor is configured to display data relating to the at least one of the valve clip position and the valve clip type.

In an embodiment, the simulation of the blood flow is a computational fluid dynamics (CFD) simulation.

In an embodiment, the one or more parameters that influence the simulation of blood flow for the mitral valve comprise at least one of calcification details, Doppler information, valve clip properties, and prior parameters based on prior simulations.

According to an embodiment, at least one of the one or more parameters comprises data relating to a library of valve clips, wherein the simulation of the blood flow for the mitral valve is conducted for each valve clip of the library of valve clips at a predetermined number of positions to determine the at least one of the valve clip position and the valve clip type.

In an embodiment, the defined one or more metrics comprise one or more parameters relating to flow characteristics of the mitral valve. The flow characteristics may be averaged over an entirety of an orifice of the mitral valve, averaged over a dedicated area of the mitral valve, and computed by removing regurgitation amounts less than a predetermined threshold.

In an embodiment, the data relating to the at least one of the valve clip position and the valve clip type comprises at least one of a model containing clinical data with a simulated valve clip, an interactive virtual valve clip as a graphical overlay about a valve model, and a color-coded valve model indicating various ones of results from the conducted simulation and the re-conducted simulation.

In an embodiment, a method of valve clip placement comprises receiving, by a processor, one or more parameters that influence a simulation of blood flow for a mitral valve; defining, by the processor, one or more metrics for an acceptable simulation result; conducting, by the processor, the simulation of the blood flow for the mitral valve based on one or more of the one or more received parameters; comparing, by the processor, results of the simulation with the defined one or more metrics; re-conducting, by the processor, the simulation of the blood flow for the mitral valve based on a re-parameterization of one or more of the one or more received parameters if the comparison indicates an unacceptable simulation result, wherein the re-conducting is performed until the acceptable simulation result is accomplished as determined by a comparison of the results of the re-conducted simulation with the defined one or more metrics; determining, by the processor, at least one of a valve clip position and a valve clip type based on the acceptable simulation result from one of the conducted simulation and the re-conducted simulation; and displaying, by a user interface in communication with the processor, data relating to the at least one of the valve clip position and the valve clip type.

In an additional embodiment, a system of valve clip placement comprises a processor configured to: receive one or more parameters that influence a simulation of blood flow for a mitral valve; define one or more metrics for an acceptable simulation result; conduct the simulation of the blood flow for the mitral valve based on one or more of the one or more received parameters, wherein the simulation of the blood flow for the mitral valve is conducted for each valve clip of a library of valve clips at a predetermined number of positions; compare results of the simulations with the defined one or more metrics; determine at least one of a valve clip position and a valve clip type based on the acceptable simulation result from one of the conducted simulations. A user interface in communication with the processor is configured to display data relating to the at least one of the valve clip position and the valve clip type.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a diagram illustrating the anatomy of a mitral valve;

FIG. 2 illustrates a system for predicting an optimal position for a valve clip to be placed and/or an optimal type of valve clip to be used, according to embodiments provided herein; and

FIG. 3 is a diagram depicting an exemplary illustration of regurgitation along the valve orifice without a clip based upon a pretreatment computational fluid dynamics (CFD) calculation, according to an embodiment;

FIGS. 4A and 4B are diagrams depicting exemplary illustrations of regurgitation along the valve orifice with a clip at two different positions based upon CFD calculations, according to an embodiment;

FIG. 5 is a diagram depicting results of CFD calculations overlaid on a valve model, according to an embodiment;

FIG. 6 is a flowchart for a prediction process for predicting an optimal position for a valve clip to be placed and/or an optimal type of valve clip to be used, according to embodiments; and

FIG. 7 is an exemplary computing environment in which embodiments disclosed herein may be implemented.

### DETAILED DESCRIPTION

Embodiments of the present invention relate to a method and system for calculating an optimal position for a valve clip to be placed and/or an optimal type of valve clip to be used for placement in a valve, based upon a simulation of the blood flow for the valve. Although embodiments are discussed with reference to a mitral valve, the invention is not so limited, and embodiments may be applied to other valves.

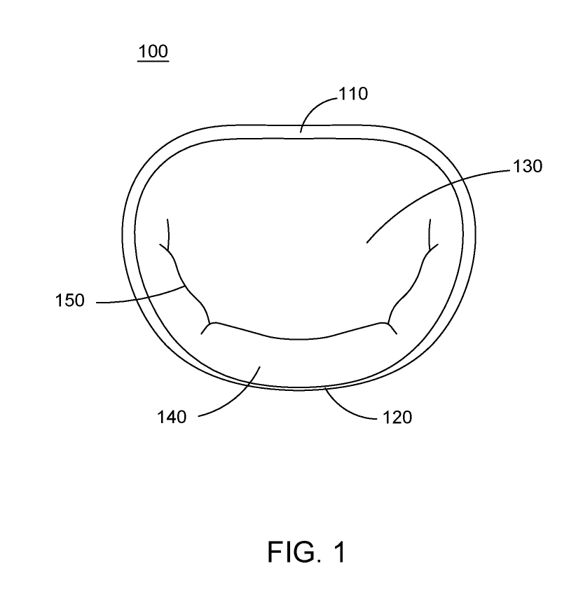

With reference to FIG. 1, the anatomy of a mitral valve 100 is illustrated. The mitral valve 100 is comprised of an anterior annulus 110, a posterior annulus 120, an anterior leaflet 130, a posterior leaflet 140, and an orifice 150. The valve 100 may become damaged, requiring the leaflets 130, 140 to be clipped together with a valve clip to repair the valve. Due to the problems noted above with respect to the placement and adjustment of a mitral valve clip, embodiments disclosed herein provide a method and system for predicting an optimal valve clip position and type for placement in a patient. The benefits include establishing an optimal position for placement of a valve clip upon a first deployment attempt during intervention; thus, no readjustment or manipulation of the valve clip may be necessary after the first deployment attempt. Other benefits include reduced anatomical damage to the valve, which can be caused by multiple and successive positioning attempts of the clip to attain the correct position. A one-time deployment attempt reduces radiation dose exposure, from the need for X-ray to guide the cardiologist in attempting to position the valve clip. Usage of contrast media and the interventional time to the patient are also reduced.

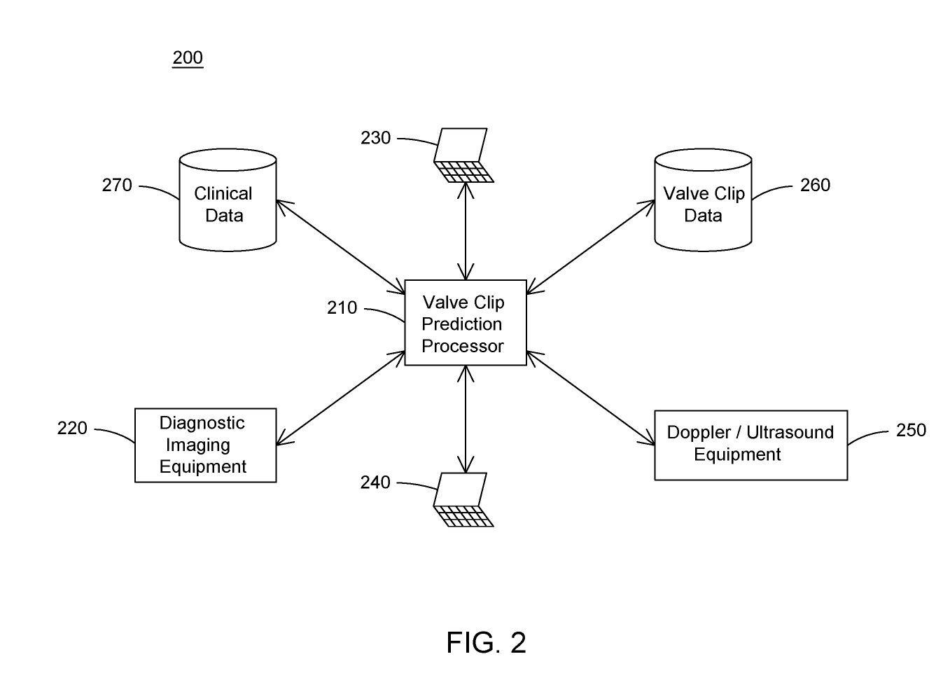

FIG. 2 illustrates an exemplary system 200 for predicting an optimal position for a valve clip to be placed and/or an optimal type of valve clip to be used, for repairing the mitral valve, according to embodiments disclosed herein. The system 200 includes a valve clip prediction processor 210, which uses a simulation of the blood flow for the mitral valve to calculate the position and/or type of valve. The simulation is based upon several parameters that influence the result of the simulation. These contributing parameters are inputted to the valve clip prediction processor 210 from various sources. The contributing parameters may include, but are not limited to, calcification details, information from a 3D or 4D model of the valve, valve clip properties, and prior flow simulation.

According to an embodiment, calcification details may be observed and determined from a prior 3D rotational data scan (i.e., a diagnostic imaging scan) of the heart. The equipment and processing utilized to conduct the diagnostic imaging scan (diagnostic imaging equipment 220) may, in an embodiment, transmit the calcification details to the valve clip prediction processor 210. The diagnostic imaging scan may include, but is not limited to, one or more of a rotational 3D data scan, a computed tomography (CT) scan, an MRI, an XA scan, and an Ultrasound. Alternatively, measurements and/or calculations to generate the calcification details may be inputted by, for example, a physician, lab technician, user, or the like, and transmitted to the valve clip prediction processor 210 from one or more computing devices 230, 240. The calcification details may include mass, size, and/or location of calcification in the heart and/or about the valve 100. In an embodiment, the valve clip prediction processor 210 may classify the calcification based on the received calcification details. Classification may include a determination of the type of calcification, for example in terms of minimal, normal, or extreme calcification based on the calcification details. Weighting of the type of calcification may also be dependent on other factors, such as, for example, age of the patient. The one or more computing devices 230, 240 may include a desktop computer, a laptop computer, a mobile device, a tablet, or any type of computing device known to those of ordinary skill in the art.

Doppler information may be provided from a prior transeophageal echocardiogram (TEE). The equipment and processing used to obtain the Doppler information (Doppler/ultrasound equipment 250) may, in an embodiment, transmit the Doppler information to the valve clip prediction processor 210. The equipment 250 may include an ultrasound transducer in a probe for collecting Doppler information of the heart, including various geometric measurements. Alternatively, any analysis to supplement the Doppler information conducted by a processor in TEE collection devices or by the physician, lab technician, user, or the like may be transmitted to the valve clip prediction processor 210 from one or more computing devices 230, 240. The Doppler information may provide tissue density information for the leaflets 130, 140 of the valve 100, such as whether the tissue is hard, soft, thick, thin, or other characteristics of interest. Doppler information may also include location and size specifics of the valve 100 and valve leaflets 130, 140. Color Doppler information can suggest fluid dynamics about the valve 100 for location purposes. The valve clip prediction processor 210 may generate a 3D model of the valve 100 based on the collected Doppler information. A 4D model may also be generated, adding a time component for fluid transfer relative to time about the 3D model.

With continued reference to FIG. 2, valve clip data from one or more databases or other sources 260 may be inputted to the valve clip prediction processor 210. The valve clip data may include valve clip properties, such as but not limited to size and mass, that may be provided for various types of valve clips that may be designed and built by one or more manufacturers. The valve clip properties may be transmitted to the valve clip prediction processor 210 regularly or when updates to the data become available (for example, when newly-designed clips become available).

Clinical data from one or more clinical databases or other sources 270 is also, according to an embodiment, inputted to the valve clip prediction processor 210 for use in generating the simulation of the blood flow for the mitral valve 100. The clinical data may include data or parameters collected by prior computational fluid dynamics (CFD) simulations. In an embodiment, CFD simulation data is obtained from formerly-collected clinical data regarding the valve 100. The valve clip prediction processor 210 may be uploaded with prior calculations and parameters based on the prior CFD simulations. Additional CFD simulations may be conducted for various valve models.

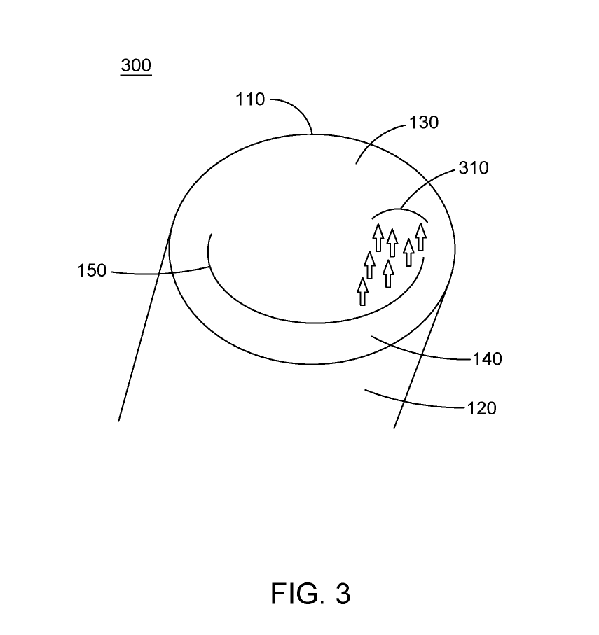

FIG. 3 is a diagram 300 depicting an exemplary illustration of regurgitation 310 along the valve orifice 150 (the opening between the posterior leaflet 140 and the anterior leaflet 130 of a mitral valve) without a clip based upon a pretreatment CFD calculation. The less regurgitation, the better. Thus, according to an embodiment, the valve clip prediction processor 210, with the various inputted, contributing parameters, performs simulations of the blood for the mitral valve 100 to determine an optimal position for a valve clip to be placed and/or an optimal type of valve clip to be used. Clips may be selected from a library of available clips as provided by the valve clip database 260 for usage in the CFD simulations. A valve clip and/or a clip position may be selected or determined to be “preferred” based upon flow characteristics (e.g., minimum regurgitation rate) calculated for the valve clip and/or the clip position under the CFD simulation. In an embodiment, regurgitation is calculated along the mitral valve orifice 150 for a predefined number of locations and/or for a predefined number of valve clips. In an embodiment, at least five clip positions are considered as input for the CFD calculation: left, lower left, center, lower right, and right; although more or fewer clip positions can be used.

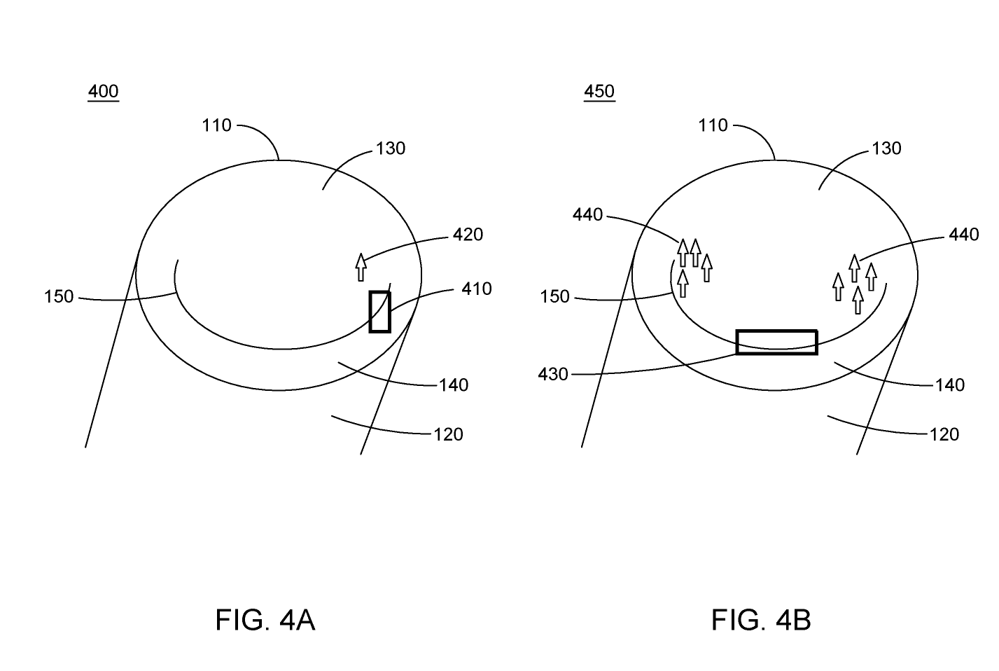

FIGS. 4A and 4B are diagrams 400 and 450, respectively, depicting exemplary illustrations of regurgitation along the valve orifice 150 with a clip at two different positions based upon CFD calculations. The CFD calculation results show remaining regurgitation along the valve orifice 150 for two different clip positions. In particular, FIG. 4A shows remaining regurgitation 420 along the valve orifice 150 with a clip position 410 (at the right of the leaflets 130, 140). FIG. 4B shows remaining regurgitation 440 along the valve orifice 150 with a clip position 430 (at the center of the leaflets 130, 140).

In an embodiment, one or more metrics may be defined to analyze the effective regurgitation resulting from the CFD calculations. In embodiments, the effective regurgitation may be averaged over the entirety of the leaflets 130, 140; averaged over a dedicated area of the leaflets 130, 140; or computed by removing regurgitation amounts less than a predetermined threshold. The one or more metrics may be based on the clinical situation and may be entered by a physician, lab technician, user, or the like, and transmitted to the valve clip prediction processor 210 from one or more computing devices 230, 240.

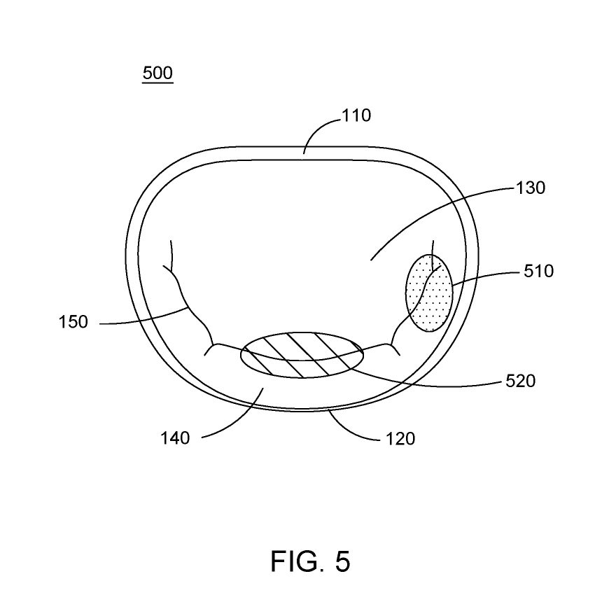

FIG. 5 is a diagram 500 depicting results of CFD calculations overlaid on a valve model, according to an embodiment, which may be provided on a user interface of one or more computing devices 230, 240, for review and analysis by a physician, lab technician, or other user. In the embodiment shown in FIG. 5, clip positions 510 and 520 are shown. In an embodiment, the results may be marked with, for example, different patterns or other identifying features to distinguish between the clip positions. In an embodiment, the clip positions 510 and 520 may be color-coded, with blue indicating a good position and red indicating a bad position, as one example. In an additional example, additional clip positions may be shown on the valve model, with each numbered according to a ranking from best to worst position.

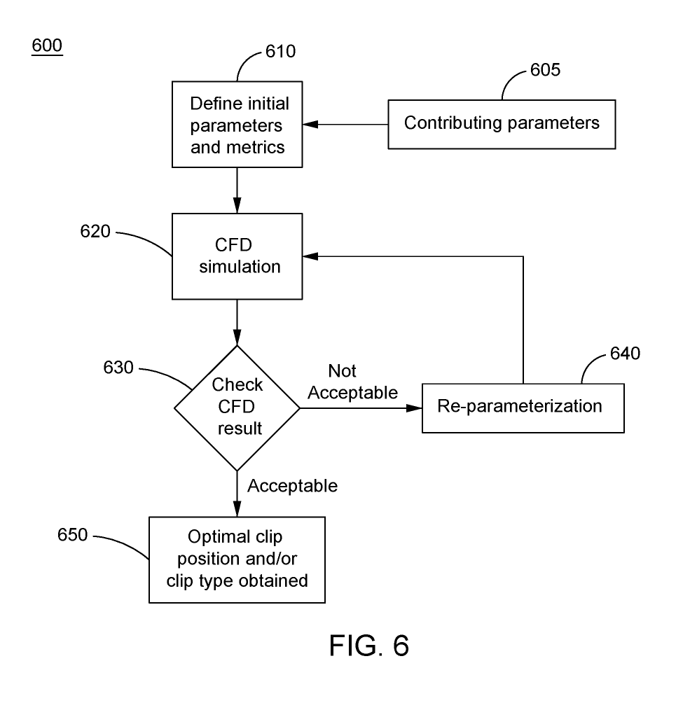

FIG. 6 is a flowchart 600 for a prediction process for predicting an optimal position for a valve clip to be placed and/or an optimal type of valve clip to be used, according to an embodiment.

At 610, one or more contributing parameters 605 are defined to be used in determining an optimal position for a valve clip to be placed and/or an optimal type of valve clip to be used, for repairing the mitral valve. As described above, the contributing parameters may include, but are not limited to, calcification details, information from a 3D or 4D model of the valve, valve clip properties, and prior flow simulation; which are used in a simulation of the blood flow for the mitral valve.

Also at 610, one or more metrics may be established to be utilized by the valve clip prediction processor 210 to measure the quality of a simulation conducted by the valve clip prediction processor 210. In some embodiments, the one or more metrics may be previously defined and provided to the valve clip prediction processor 210 at this step. The metrics may be based upon blood flow simulations, in time, conducted in either 3D or 2D space. The metrics may be set to ensure that valve regurgitation and valve leakage are minimized.

At 620, the valve clip prediction processor 210 conducts a simulation utilizing the parameters collected and the metrics defined. The simulation may be CFD-simulated to predict at least one of the optimal clip type (e.g. dimension, mass, etc.) and optimal clip position. The simulation may be transmitted to a user interface and displayed in a 3D rotational image and/or as a 2D image. The predicted optimal clip type and position for its placement may be shown overlaid in the image among the displayed valve.

At 630, the valve clip prediction processor 210 may determine the acceptability of the simulation results in a comparison with the defined metrics. If the results are unacceptable or unsatisfactory as determined by the valve clip prediction processor 210, or even by the user, then a re-parameterization may be required at 640. And thus, a successive simulation may be conducted, such as by CFD, for another prediction by the valve clip prediction processor 210 for at least one of the optimal clip type and optimal clip position. In some embodiments, new or additional parameters may be obtained by the valve clip position processor 210 for the re-parameterization and/or simulation to determine the new optimal clip type and/or optimal clip position. The simulation may be recalculated by using different parameters. In some instances, the parameters may be modified before simulation and/or re-calculation based on deviations from the optimal results in the initial simulation. This iterative process of checking the simulation results at 630 and cycling through 640 and 620 and back to 630 may be repeated until the accepted criteria, as defined by the one or more metrics, are met.

When the results of the simulation are acceptable, as determined by the valve clip prediction processor 210 with regards to the one or more metrics, then the optimal clip position and/or clip type is obtained (650). The valve clip prediction processor 210 may then transmit to a user interface of, for example, one of the computing devices 230, 240 for displaying to a user, such as the cardiologist or physician, appropriate instructions or other guidance information to appropriately place and affix the valve clip into the optimal position.

In another embodiment, the CFD simulation may be computed for a predefined number of locations and/or for a predefined number of valve clips. For example, a user may wish to determine among a library or a preselected group of clip types the optimal clip type and the optimal position among predefined clip positions. Thus, in an embodiment, the valve clip prediction processor 210 performs a CFD simulation for each clip among the library or preselected clip types at each of the predefined clip positions. In an embodiment, the results may be compared with the one or more metrics and accordingly ranked. The results (or a predefined number of the results) may be provided to a user as described above.

The valve clip prediction processor 210 may provide the results of the simulation as basis for guidance for deployment of the clip. The processor 210 may show the simulated clip in the 3D model containing clinical data. The processor 210 may also provide means to a user to move the simulated or virtual clip in 3D space or in 2D space or as a graphical overlay about the valve model. The processor 210 may also provide recalculations for simulation based upon positioning of the selected virtual clip in the 3D or 2D model. Thus, the processor may allow for user interaction with the simulation to select and try various clips at an optimal position or position chosen by the user. The user interface or any other display may show both the virtual and actual clip for the guidance of the clip during deployment and positioning. The processor 210 may also provide for vector correction guidance based upon deviation of the actual clip from the virtual clip and vice versa.

In an embodiment, a user may add a simulated clip to any position of the valve model and start a CFD calculation. The result of this CFD calculation may be determined, with a representative drawing showing resulting regurgitation overlaid on a valve model. As another example, a user may add a simulated clip to any position of the valve model and start a CFD calculation, the result of which is compared to a CFD calculation using predefined metrics. Based on the comparison, the clip positions may be color-coded to indicate the results (e.g., “good” vs. “bad”) and overlaid on a valve model.

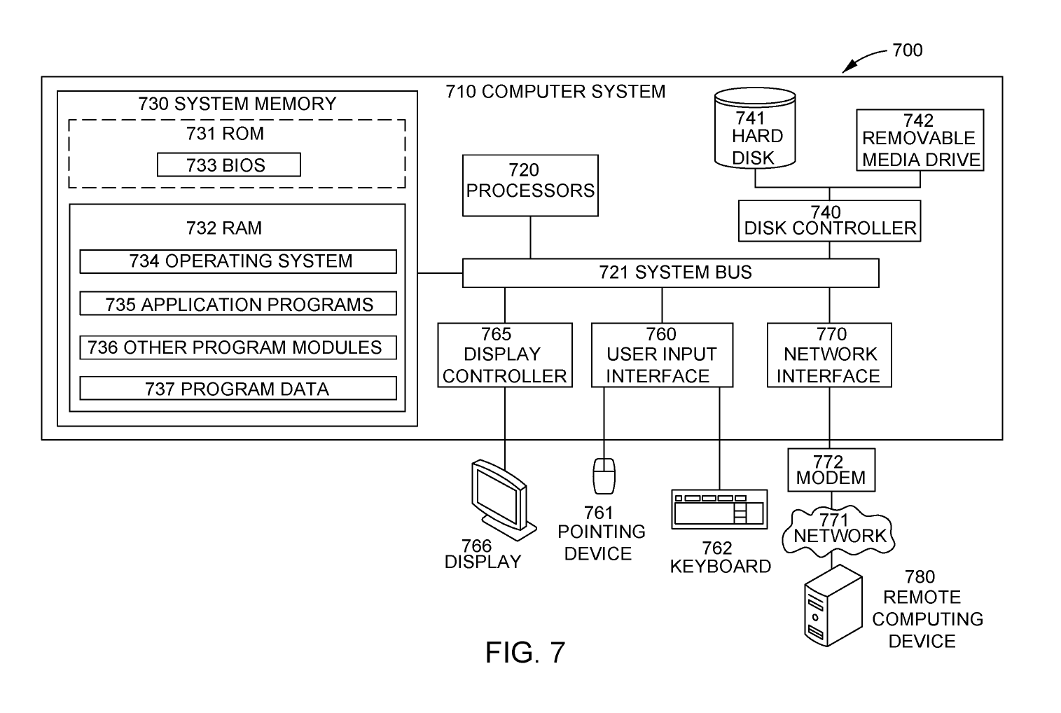

FIG. 7 illustrates an exemplary computing environment 700 within which embodiments of the invention may be implemented. Computing environment 700 may include computer system 710, which is one example of a computing system upon which embodiments of the invention may be implemented. Computers and computing environments, such as computer 710 and computing environment 700, are known to those of skill in the art and thus are described briefly here.

As shown in FIG. 7, the computer system 710 may include a communication mechanism such as a bus 721 or other communication mechanism for communicating information within the computer system 710. The system 710 further includes one or more processors 720 coupled with the bus 721 for processing the information. The processors 720 may include one or more central processing units (CPUs), graphical processing units (GPUs), or any other processor known in the art.

The computer system 710 also includes a system memory 730 coupled to the bus 721 for storing information and instructions to be executed by processors 720. The system memory 730 may include computer readable storage media in the form of volatile and/or nonvolatile memory, such as read only memory (ROM) 731 and/or random access memory (RAM) 732. The system memory RAM 732 may include other dynamic storage device(s) (e.g., dynamic RAM, static RAM, and synchronous DRAM). The system memory ROM 731 may include other static storage device(s) (e.g., programmable ROM, erasable PROM, and electrically erasable PROM). In addition, the system memory 730 may be used for storing temporary variables or other intermediate information during the execution of instructions by the processors 720. A basic input/output system 733 (BIOS) containing the basic routines that help to transfer information between elements within computer system 710, such as during start-up, may be stored in ROM 731. RAM 732 may contain data and/or program modules that are immediately accessible to and/or presently being operated on by the processors 720. System memory 730 may additionally include, for example, operating system 734, application programs 735, other program modules 736 and program data 737.

The computer system 710 also includes a disk controller 740 coupled to the bus 721 to control one or more storage devices for storing information and instructions, such as a magnetic hard disk 741 and a removable media drive 742 (e.g., floppy disk drive, compact disc drive, tape drive, and/or solid state drive). The storage devices may be added to the computer system 710 using an appropriate device interface (e.g., a small computer system interface (SCSI), integrated device electronics (IDE), Universal Serial Bus (USB), or FireWire).

The computer system 710 may also include a display controller 765 coupled to the bus 721 to control a display or monitor 766, such as a cathode ray tube (CRT) or liquid crystal display (LCD), for displaying information to a computer user. The computer system 710 includes an input interface 760 and one or more input devices, such as a keyboard 762 and a pointing device 761, for interacting with a computer user and providing information to the processors 720. The pointing device 761, for example, may be a mouse, a trackball, or a pointing stick for communicating direction information and command selections to the processors 720 and for controlling cursor movement on the display 766. The display 766 may provide a touch screen interface which allows input to supplement or replace the communication of direction information and command selections by the pointing device 761.

The computer system 710 may perform a portion or all of the processing steps of embodiments of the invention in response to the processors 720 executing one or more sequences of one or more instructions contained in a memory, such as the system memory 730. Such instructions may be read into the system memory 730 from another computer readable medium, such as a hard disk 741 or a removable media drive 742. The hard disk 741 may contain one or more datastores and data files used by embodiments of the present invention. Datastore contents and data files may be encrypted to improve security. The processors 720 may also be employed in a multi-processing arrangement to execute the one or more sequences of instructions contained in system memory 730. In alternative embodiments, hard-wired circuitry may be used in place of or in combination with software instructions. Thus, embodiments are not limited to any specific combination of hardware circuitry and software.

As stated above, the computer system 710 may include at least one computer readable medium or memory for holding instructions programmed according to embodiments provided herein and for containing data structures, tables, records, or other data described herein. The term “computer readable medium” as used herein refers to any medium that participates in providing instructions to the processors 720 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 741 or removable media drive 742. Non-limiting examples of volatile media include dynamic memory, such as system memory 730. Non-limiting examples of transmission media include coaxial cables, copper wire, and fiber optics, including the wires that make up the bus 721. Transmission media may also take the form of acoustic or light waves, such as those generated during radio wave and infrared data communications.

The computing environment 700 may further include the computer system 710 operating in a networked environment using logical connections to one or more remote computers, such as remote computer 780. Remote computer 780 may be a personal computer (laptop or desktop), a mobile device, a server, a router, a network PC, a peer device or other common network node, and typically includes many or all of the elements described above relative to computer system 710. When used in a networking environment, computer system 710 may include modem 772 for establishing communications over a network 771, such as the Internet. Modem 772 may be connected to system bus 721 via user network interface 770, or via another appropriate mechanism.

Network 771 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 710 and other computers (e.g., remote computing system 780). The network 771 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 771.

As described herein, the various systems, subsystems, agents, managers and processes can be implemented using hardware components, software components and/or combinations thereof.

Although the present invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

We claim:

1. A system for valve clip placement, the system comprising:
a processor configured to:
receive one or more parameters that influence a simulation of blood flow for a mitral valve;
define one or more metrics for an acceptable simulation result;
conduct the simulation of the blood flow for the mitral valve based on one or more of the one or more received parameters;
compare results of the simulation with the defined one or more metrics;
re-conduct the simulation of the blood flow for the mitral valve based on a re-parameterization of one or more of the one or more received parameters if the comparison indicates an unacceptable simulation result, wherein the re-conducting is performed until the acceptable simulation result is accomplished as determined by a comparison of the results of the re-conducted simulation with the defined one or more metrics;
determine at least one of a valve clip position and a valve clip type based on the acceptable simulation result from one of the conducted simulation and the re-conducted simulation;
a user interface in communication with the processor to display data relating to the at least one of the valve clip position and the valve clip type.

2. The system of claim 1, wherein the simulation of the blood flow is a computational fluid dynamics (CFD) simulation.

3. The system of claim 1, wherein the one or more parameters that influence the simulation of blood flow for the mitral valve comprise at least one of calcification details, Doppler information, valve clip properties, and prior parameters based on prior simulations.

4. The system of claim 1, wherein at least one of the one or more parameters comprises data relating to a library of valve clips, wherein the simulation of the blood flow for the mitral valve is conducted for each valve clip of the library of valve clips at a predetermined number of positions to determine the at least one of the valve clip position and the valve clip type.

5. The system of claim 1, wherein the defined one or more metrics comprise one or more parameters relating to flow characteristics of the mitral valve.

6. The system of claim 5, wherein the flow characteristics are at least one of averaged over an entirety of an orifice of the mitral valve, averaged over a dedicated area of the mitral valve, and computed by removing regurgitation amounts less than a predetermined threshold.

7. The system of claim 1, wherein the data relating to the at least one of the valve clip position and the valve clip type comprises at least one of a model containing clinical data with a simulated valve clip, an interactive virtual valve clip as a graphical overlay about a valve model, and a color-coded valve model indicating various ones of results from the conducted simulation and the re-conducted simulation.

8. A method of valve clip placement, the method comprising:
receiving, by a processor, one or more parameters that influence a simulation of blood flow for a mitral valve;
defining, by the processor, one or more metrics for an acceptable simulation result;
conducting, by the processor, the simulation of the blood flow for the mitral valve based on one or more of the one or more received parameters;
comparing, by the processor, results of the simulation with the defined one or more metrics;
re-conducting, by the processor, the simulation of the blood flow for the mitral valve based on a re-parameterization of one or more of the one or more received parameters if the comparison indicates an unacceptable simulation result, wherein the re-conducting is performed until the acceptable simulation result is accomplished as determined by a comparison of the results of the re-conducted simulation with the defined one or more metrics;
determining, by the processor, at least one of a valve clip position and a valve clip type based on the acceptable simulation result from one of the conducted simulation and the re-conducted simulation; and
displaying, by a user interface in communication with the processor, data relating to the at least one of the valve clip position and the valve clip type.

9. The method of claim 8, wherein the simulation of the blood flow is a computational fluid dynamics (CFD) simulation.

10. The method of claim 8, wherein the one or more parameters that influence the simulation of blood flow for the mitral valve comprise at least one of calcification details, Doppler information, valve clip properties, and prior parameters based on prior simulations.

11. The method of claim 8, wherein at least one of the one or more parameters comprises data relating to a library of valve clips, wherein the simulation of the blood flow for the mitral valve is conducted for each valve clip of the library of valve clips at a predetermined number of positions to determine the at least one of the valve clip position and the valve clip type.

12. The method of claim 8, wherein the defined one or more metrics comprise one or more parameters relating to flow characteristics of the mitral valve.

13. The method of claim 12, wherein the flow characteristics are at least one of averaged over an entirety of an orifice of the mitral valve, averaged over a dedicated area of the mitral valve, and computed by removing regurgitation amounts less than a predetermined threshold.

14. The method of claim 8, wherein the data relating to the at least one of the valve clip position and the valve clip type comprises at least one of a model containing clinical data with a simulated valve clip, an interactive virtual valve clip as a graphical overlay about a valve model, and a color-coded valve model indicating various ones of results from the conducted simulation and the re-conducted simulation.

15. A system for valve clip placement, the system comprising:
a processor configured to:
receive one or more parameters that influence a simulation of blood flow for a mitral valve;
define one or more metrics for an acceptable simulation result;
conduct the simulation of the blood flow for the mitral valve based on one or more of the one or more received parameters, wherein the simulation of the blood flow for the mitral valve is conducted for each valve clip of a library of valve clips at a predetermined number of positions;
compare results of the simulations with the defined one or more metrics;
determine at least one of a valve clip position and a valve clip type based on the acceptable simulation result from one of the conducted simulations;
a user interface in communication with the processor to display data relating to the at least one of the valve clip position and the valve clip type.

16. The system of claim 15, wherein the simulation of the blood flow is a computational fluid dynamics (CFD) simulation.

17. The system of claim 15, wherein the one or more parameters that influence the simulation of blood flow for the mitral valve comprise at least one of calcification details, Doppler information, valve clip properties, and prior parameters based on prior simulations.

18. The system of claim 15, wherein the defined one or more metrics comprise one or more parameters relating to flow characteristics of the mitral valve.

19. The system of claim 18, wherein the flow characteristics are at least one of averaged over an entirety of an orifice of the mitral valve, averaged over a dedicated area of the mitral valve, and computed by removing regurgitation amounts less than a predetermined threshold.

20. The system of claim 15, wherein the data relating to the at least one of the valve clip position and the valve clip type comprises at least one of a model containing clinical data with a simulated valve clip, an interactive virtual valve clip as a graphical overlay about a valve model, and a color-coded valve model indicating various ones of results from the conducted simulation and the re-conducted simulation.
